(19) United States
(12) Patent Application Publication
(10) Pub. No.: US 2025/0276712 A1
(43) Pub. Date: Sep. 4, 2025

(54) VEHICLE CONTROL DEVICE

(71) Applicant: HONDA MOTOR CO., LTD., Tokyo (JP)

(72) Inventor: Sachio KOBAYASHI, Tokyo (JP)

(73) Assignee: HONDA MOTOR CO., LTD., Tokyo (JP)

(21) Appl. No.: 19/056,772

(22) Filed: Feb. 19, 2025

(30) Foreign Application Priority Data
Mar. 4, 2024 (JP) 2024-032274

(51) Int. Cl. B60W 50/14; B60W 30/09

(52) U.S. Cl. CPC B60W 50/14; B60W 30/09; B60W 2050/143; B60W 2510/202; B60W 2540/225

(57) ABSTRACT

A vehicle control device having circuitry configured to: recognize a surrounding situation of a vehicle; recognize a driving status of the vehicle involving a driver; and issue an alarm to the driver via a predetermined alarm device based on the recognized surrounding situation and the recognized driving status. The circuitry is configured to recognize the driving status including a steering condition with respect to the vehicle and a direction of a line of sight of the driver and issue the alarm at a predetermined alarm intensity when a predetermined execution condition is satisfied based on the surrounding situation, and in a case where at least one of the steering condition and the direction of the line of sight satisfies a predetermined condition, the circuitry is configured to make the execution condition stricter and/or decrease the alarm intensity as compared with a case where the predetermined condition is not satisfied.

### CROSS-REFERENCE TO RELATED APPLICATIONS

This application is based on and claims priority under 35 USC 119 from Japanese Patent Application No. 2024-032274 filed on Mar. 4, 2024, the contents of which are incorporated herein by reference.

### TECHNICAL FIELD

The present disclosure relates to a vehicle control device that controls a vehicle.

### BACKGROUND ART

In recent years, active efforts have been made to provide access to a sustainable transportation system in consideration of vulnerable traffic participants.

As one of these efforts, research and development on driving assist techniques and automated driving techniques for vehicles such as automobiles have been made in order to further improve safety and convenience of traffic.

As an example of the driving assist technique, Japanese Patent Application Laid-Open Publication No. 2022-059939A listed below discloses a technique in which, as control related to traveling close to an edge of a lane from traveling in a center range of the lane, departure prevention control of returning the traveling close to the edge of the lane to the center of the lane is executed.

However, in the related art, there is room for improvement from the viewpoint of appropriately issuing an alarm to a driver while preventing excessive alarming that may bother the driver.

The present disclosure relates to providing a vehicle control device capable of appropriately issuing an alarm to a driver while preventing excessive alarming that may bother the driver.

### SUMMARY

An aspect of the present disclosure relates to a vehicle control device for controlling a vehicle, in which the vehicle control device comprising circuitry configured to:
recognize a surrounding situation of the vehicle;
recognize a driving status of the vehicle involving a driver; and
issue an alarm to the driver via a predetermined alarm device based on the recognized surrounding situation and the recognized driving status, in which
the circuitry is configured to recognize the driving status including a steering condition with respect to the vehicle and a direction of a line of sight of the driver,
the circuitry is configured to issue the alarm at a predetermined alarm intensity when a predetermined execution condition is satisfied based on the surrounding situation, and
in a case where at least one of the steering condition and the direction of the line of sight satisfies a predetermined condition, the circuitry is configured to make the execution condition stricter and/or decrease the alarm intensity as compared with a case where the predetermined condition is not satisfied.

According to the present disclosure, it is possible to provide a vehicle control device capable of appropriately issuing an alarm to a driver while preventing excessive alarming that may bother the driver.

### BRIEF DESCRIPTION OF DRAWINGS

Exemplary embodiments of the present disclosure will be described in detail based on the following figures, wherein:

FIG. 1 is a block diagram illustrating a schematic configuration of a vehicle including a control device according to an embodiment;

FIG. 2 is a flowchart illustrating an example of alarm control processing executed by the control device according to the embodiment; and

FIG. 3 illustrates an example of an alarm control table referred to by the control device according to the embodiment.

### DESCRIPTION OF EMBODIMENTS

Hereinafter, an embodiment of a vehicle control device according to the present disclosure will be described with reference to the drawings. The following embodiment does not limit the present disclosure, and not all elements described in the following embodiment are essential to the present disclosure. Further, two or more elements described in the following embodiment may be freely combined without departing from the gist of the present disclosure. Hereinafter, the same or similar elements are denoted by the same or similar reference signs, and a description thereof may be omitted or simplified.

### Vehicle

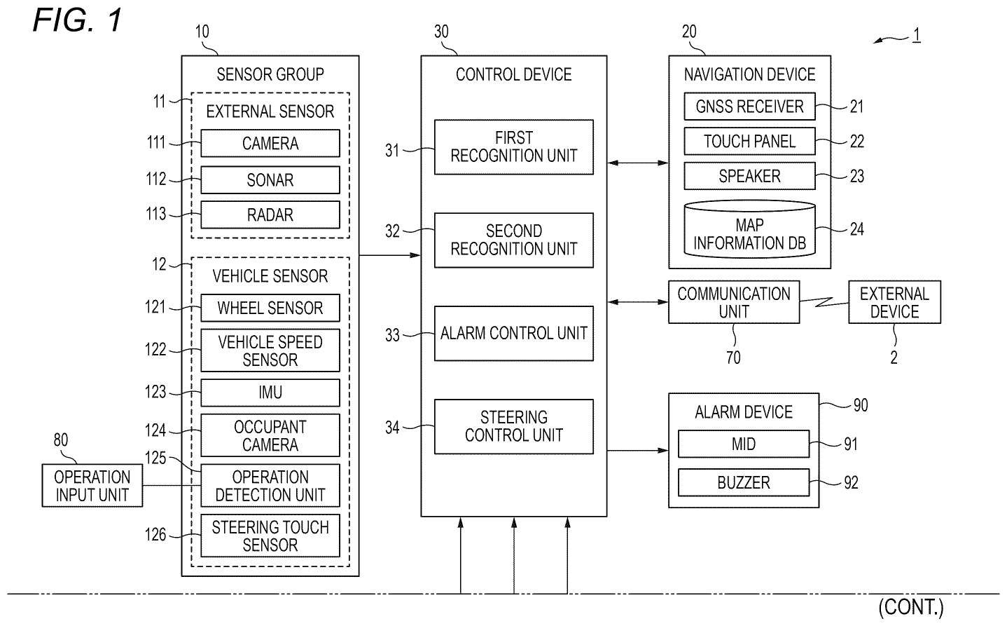

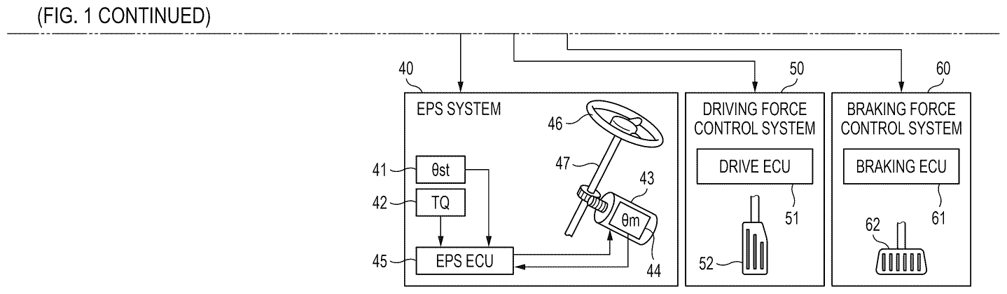

First, a vehicle according to the present embodiment will be described. A vehicle 1 according to the present embodiment illustrated in FIG. 1 (hereinafter, also referred to as a “host vehicle”) is an automobile including a drive source (not illustrated), and wheels (not illustrated) including drive wheels driven by power of the drive source and steered wheels that are steerable. As an example, the vehicle 1 may be a four-wheeled automobile having a pair of left and right front wheels and a pair of left and right rear wheels.

The drive source of the vehicle 1 may be an electric motor, an internal combustion engine such as a gasoline engine or a diesel engine, or a combination of an electric motor and an internal combustion engine. The drive source of the vehicle 1 may drive the pair of left and right front wheels, the pair of left and right rear wheels, or the four wheels including the pair of left and right front wheels and the pair of left and right rear wheels. The front wheels and the rear wheels of the vehicle 1 may all be steerable steered wheels, or the front wheels or the rear wheels may be steerable steered wheels.

The vehicle 1 includes a sensor group 10, a navigation device 20, a control device 30 that is an example of the vehicle control device of the present disclosure, an electric power steering (EPS) system 40, a driving force control system 50, a braking force control system 60, a communication unit 70, an operation input unit 80, and an alarm device 90.

The sensor group 10 includes an external sensor 11 that acquires information on a periphery of the vehicle 1 (hereinafter also referred to as “peripheral information”), and a vehicle sensor 12 that acquires information on the vehicle 1 (hereinafter also referred to as “vehicle information”). Information (in other words, detection values) acquired by each sensor in the sensor group 10 is output to the control device 30, and is used for control of the vehicle 1 (hereinafter, also referred to as “vehicle control”) performed by the control device 30.

The external sensor 11 includes, for example, a camera 111, a sonar 112, and a radar 113. The camera 111 is a digital camera that images the periphery of the vehicle 1 including the front of the vehicle 1 and outputs image data of the obtained peripheral image to the control device 30. As the camera 111, for example, a digital camera using an imaging element such as a charge-coupled device (CCD) or a complementary metal oxide semiconductor (CMOS) can be employed.

The sonar 112 emits sound waves to the periphery of the vehicle 1 (for example, the front, the rear, and lateral sides of the vehicle 1), and receives reflected sounds from an object present around the vehicle 1, thereby detecting a distance to the object, an azimuth of the object, and the like. The radar 113 emits radio waves to the periphery of the vehicle 1 including the front of the vehicle 1, and receives reflected waves from an object present around the vehicle 1, thereby detecting a distance to the object, an azimuth of the object, and the like. As the radar 113, for example, a millimeter wave radar can be employed.

The external sensor 11 may include light detection and ranging (LiDAR) instead of or in addition to the sonar 112 and the radar 113. In this case, the LiDAR emits laser light to the periphery of the vehicle 1 including the front of the vehicle 1, and receives reflected light from an object present around the vehicle 1, thereby detecting a distance to the object, an azimuth of the object, and the like.

The vehicle sensor 12 includes, for example, a wheel sensor 121, a vehicle speed sensor 122, an inertial measurement unit (IMU) 123, an occupant camera 124, an operation detection unit 125, and a steering touch sensor 126.

The wheel sensor 121 detects a rotation angle of one or more wheels among the wheels of the vehicle 1. As an example, the wheel sensor 121 detects rotation angles of a left rear wheel and a right rear wheel. As the wheel sensor 121, for example, an angle sensor or a displacement sensor can be employed.

The vehicle speed sensor 122 detects a vehicle speed VP that is a travel speed of the vehicle 1 (in other words, a movement speed of a vehicle body). For example, the vehicle speed sensor 122 detects the vehicle speed VP based on a rotation speed of a counter shaft (not illustrated) provided in the vehicle 1.

The inertial measurement unit 123 detects angular velocities of the vehicle 1 in a pitch direction, a roll direction, and a yaw direction, and accelerations of the vehicle 1 in a front-rear direction, a left-right direction, and an upper-lower direction. The vehicle sensor 12 may include, instead of the inertial measurement unit 123, an acceleration sensor that detects an acceleration of the vehicle 1 in a predetermined direction and a gyro sensor that detects an angular velocity of the vehicle 1 in a predetermined direction.

The occupant camera 124 is a digital camera that images a vehicle interior of the vehicle 1 and outputs image data of the obtained vehicle interior image to the control device 30. For example, the occupant camera 124 may be a so-called “driver monitor camera” that is provided so as to be able to image the head of an occupant from the front (in other words, image the face) who sits on the driver's seat of the vehicle 1 (hereinafter, also referred to as a “driver”). Similarly to the camera 111, a digital camera using an imaging element such as a CCD or a CMOS can be employed as the occupant camera 124. In the present embodiment, image data of a vehicle interior image obtained by the occupant camera 124 imaging the vehicle interior of the vehicle is information with which a direction of a line of sight of the driver can be specified.

The operation detection unit 125 detects an operation performed by using the operation input unit 80 that is provided to be operable by the driver. In the present embodiment, the operation input unit 80 can include, for example, an operation button (not illustrated) for receiving an operation to switch between on (in other words, operation) and off (in other words, non-operation) of an LKAS described later. In this case, the operation detection unit 125 can detect the operation of turning on/off the LKAS.

The steering touch sensor 126 detects whether a steering 46 of the vehicle 1 is gripped appropriately. For example, the steering touch sensor 126 is implemented by a capacitance sensor or the like. In this case, the capacitance sensor is provided at a portion touched by the driver when the steering 46 is gripped appropriately.

The navigation device 20 includes, for example, a global navigation satellite system (GNSS) receiver 21, a touch panel 22, and a speaker 23. The navigation device 20 includes a storage unit (not illustrated) implemented by a flash memory or the like. The storage unit of the navigation device 20 stores a map information database (DB) 24 and the like.

The GNSS receiver 21 specifies a current position of the vehicle 1 (for example, a latitude and a longitude of a location where the vehicle 1 is located) based on a signals received from a GNSS satellite. For example, the navigation device 20 may acquire a detection result of the vehicle sensor 12 (for example, the wheel sensor 121 or the vehicle speed sensor 122) via the control device 30, and specify or complement the current position of the vehicle 1 by an inertial navigation system (INS) using a detection value of the vehicle sensor 12.

The touch panel 22 is implemented by combining a display device such as a liquid crystal display or an organic light emitting diode (OLED) with a pointing device (for example, a touch pad). The speaker 23 is configured to output a sound to an occupant (for example, the driver) of the vehicle 1.

For example, the navigation device 20 searches for a route leading from the current position of the vehicle 1 to a destination, which is set by the driver using the touch panel 22, by referring to the map information database 24. Then, the navigation device 20 performs route guidance using the touch panel 22 and the speaker 23 based on a route obtained by the search. The navigation device 20 may cause the touch panel 22 to perform predetermined display in accordance with an instruction from the control device 30. Further, the navigation device 20 may output, to the control device 30, predetermined information such as information indicating the specified current position of the vehicle 1 or information indicating an operation received via the touch panel 22.

The control device 30 is a computer that includes, for example, a processor configured to perform various calculations, a storage unit having a non-transitory storage medium for storing various types of information, and an input and output unit configured to control input and output of data between an inside and an outside of the control device 30 (none of which is illustrated), and executes overall control of the vehicle 1. For example, the control device 30 is implemented by one electronic control unit (ECU) or by a plurality of ECUs working in cooperation with each other. Since specific examples of control executed by the control device 30 will be described later, the description thereof will be omitted here.

The EPS system 40 includes a steering angle sensor 41, a torque sensor 42, an EPS motor 43, a resolver 44, and an EPS ECU 45.

The steering angle sensor 41 detects a steering angle θst of the steering 46 and outputs information indicating the detected steering angle θst to the EPS ECU 45. The torque sensor 42 detects a steering torque TQ that is a torque applied to the steering 46 of the vehicle 1, and outputs information indicating the detected steering torque TQ to the EPS ECU 45.

The EPS motor 43 applies a driving force or a reaction force to a steering column 47, which is coupled to the steering 46, in accordance with an instruction from the EPS ECU 45, thereby assisting the driver in operating the steering 46. The resolver 44 detects a rotation angle θm of the EPS motor 43 and outputs information indicating the detected rotation angle θm to the EPS ECU 45.

The EPS ECU 45 is a computer that includes, for example, a processor configured to perform various calculations, a storage unit having a non-transitory storage medium for storing various types of information, and an input and output unit configured to control input and output of data between an inside and an outside of the EPS ECU 45 (none of which is illustrated), and controls the EPS system 40 (for example, the EPS motor 43), and the EPS ECU 45 is implemented by one or two or more ECUs. For example, the EPS ECU 45 controls the EPS system 40 (for example, the EPS motor 43) based on the steering angle θst detected by the steering angle sensor 41, the steering torque TQ detected by the torque sensor 42, the rotation angle θm detected by the resolver 44, and the like.

The EPS system 40 (for example, the EPS ECU 45) may output information indicating the steering angle θst detected by the steering angle sensor 41, the steering torque TQ detected by the torque sensor 42, the rotation angle θm detected by the resolver 44, and the like to the control device 30. Further, the EPS system 40 (for example, the EPS ECU 45) may output information indicating a steering speed ω of the steering 46 to the control device 30. In this case, the steering speed ω is obtained by, for example, differentiating the steering angle θst with respect to time.

The driving force control system 50 includes a drive ECU 51, and is configured to control a driving force of the vehicle 1. The drive ECU 51 is a computer that includes, for example, a processor configured to perform various calculations, a storage unit having a non-transitory storage medium for storing various types of information, and an input and output unit configured to control input and output of data between an inside and an outside of the drive ECU 51 (none of which is illustrated), and controls the driving force control system 50, and the drive ECU 51 is implemented by one or more ECUs. For example, based on an operation on an accelerator pedal 52 provided in the vehicle 1, the drive ECU 51 controls the power output from the drive source of the vehicle 1. The drive ECU 51 can also control the driving force control system 50 (for example, a drive source) according to an instruction from the control device 30.

The braking force control system 60 includes a braking ECU 61, and is configured to control a braking force of the vehicle 1. The braking ECU 61 is a computer that includes, for example, a processor configured to perform various calculations, a storage unit having a non-transitory storage medium for storing various types of information, and an input and output unit configured to control input and output of data between an inside and an outside of the braking ECU 61 (none of which is illustrated), and controls the braking force control system 60, and the braking ECU 61 is implemented by one or more ECUs. For example, the braking ECU 61 controls a braking force of the vehicle 1 by controlling a brake device (not illustrated) provided in the vehicle 1 based on an operation on a brake pedal 62 provided in the vehicle 1. Here, the brake device includes, for example, a brake caliper, a cylinder that transmits a hydraulic pressure to the brake caliper, and an electric motor that generates a hydraulic pressure in the cylinder. The braking ECU 61 controls the electric motor of the brake device such that a braking force corresponding to the operation on the brake pedal 62 is generated. The braking ECU 61 can also control the braking force control system 60 (for example, a brake device) according to an instruction from the control device 30.

The communication unit 70 is a communication interface that communicates with an external device 2 according to the control of the control device 30. That is, the control device 30 can communicate with the external device 2 via the communication unit 70. Examples of the external device 2 may include a terminal device (for example, a smartphone) of the driver and a server device managed by a manufacturer of the vehicle 1. For example, a mobile communication network such as a cellular line, Wi-Fi (registered trademark), or Bluetooth (registered trademark) can be adopted for the communication between the vehicle 1 and the external device 2.

The alarm device 90 is a device that alarms the driver according to the control of the control device 30. The alarm device 90 includes, for example, a multi-information display (MID) 91 and a buzzer 92. The MID 91 is implemented by, for example, a display device such as a liquid crystal display or an OLED, and is provided at a position (for example, in a meter panel of the vehicle 1) that the driver can visually recognize. In the present embodiment, the MID 91 can display a predetermined alarm image in accordance with an instruction from the control device 30. The alarm image can be, for example, an image indicating that there is a possibility that the vehicle 1 departs from a host lane. Here, the host lane is a lane in which the vehicle 1 travels.

The buzzer 92 is configured to output a predetermined alarm sound. In the present embodiment, the buzzer 92 can output a predetermined alarm sound in accordance with an instruction from the control device 30. One of the buzzer 92 and the speaker 23 may be provided to serve both roles thereof. That is, the “buzzer 92” in the following description may be replaced with the “speaker 23”.

### Control Device

Next, the control device 30 will be described in more details. The control device 30 includes, for example, a first recognition unit 31, a second recognition unit 32, and an alarm control unit 33 as functional units implemented by the processor executing a program stored in the storage unit of the control device 30.

The first recognition unit 31 recognizes a surrounding situation of the vehicle 1. For example, the first recognition unit 31 performs sensor fusion processing on detection results obtained by some or all of the camera 111, the sonar 112, and the radar 113 in the external sensor 11, and recognizes the surrounding situation of the vehicle 1 based on a processing result.

More specifically, the first recognition unit 31 recognizes a position, a type, a speed, an acceleration, and the like of an object present around the vehicle 1. At this time, the first recognition unit 31 recognizes the position of the object as a position on absolute coordinates in which a representative point (for example, a center of gravity and a center of a drive shaft) of the vehicle 1 is set as an origin. Accordingly, a relative position between the vehicle 1 and the object present around the vehicle 1 can be recognized. In the absolute coordinates described above, the position of the object may be represented by using a representative point such as a center of gravity or a corner of the object, or may be represented as a region. Examples of objects that can be recognized by the first recognition unit 31 include traffic participants such as other vehicles and pedestrians, traveling lane boundaries such as division lines and curbs that define lanes, and road signs such as speed signs and lane type signs.

According to the first recognition unit 31, for example, a surrounding situation including an obstacle present around the vehicle 1 can be recognized. Here, examples of the obstacle may include another traffic participant (for example, another vehicle or a pedestrian) present around the vehicle 1, and a fallen object on a road.

The first recognition unit 31 can also recognize the surrounding situation including a shape of the host lane in which the vehicle 1 travels. For example, the first recognition unit 31 can recognize the shape of the host lane based on a traveling lane boundary recognized from a peripheral image or the like captured by the camera 111. Here, examples of the traveling lane boundary may include a division line, a road shoulder, a curb, a separation zone, and a guard rail that define a lane.

Further, the first recognition unit 31 can also recognize a position of the vehicle 1 with respect to the host lane (for example, a distance from the vehicle 1 to the traveling lane boundary of the host lane, or a time required until the vehicle 1 reaches the traveling lane boundary of the host lane). The first recognition unit 31 may also recognize a surrounding situation including other road events such as a stop line, a traffic light, a road sign, and a toll gate of a toll road.

The second recognition unit 32 recognizes a driving status of the vehicle 1 involving the driver. For example, the second recognition unit 32 recognizes a driving status including a steering condition with respect to the vehicle 1 and a direction of a line of sight of the driver, based on a detection result obtained by one or both of the occupant camera 124 and the steering touch sensor 126 in the vehicle sensor 12. Here, the steering condition includes, for example, one or both of the steering torque TQ applied to the steering 46 and a gripping state of the steering 46.

For example, the second recognition unit 32 can recognize the steering torque TQ based on a detection result of the torque sensor 42. For example, the second recognition unit 32 can recognize a gripping state of the steering 46 (in other words, whether the steering 46 is being gripped appropriately) based on a detection result obtained by one or both of the occupant camera 124 and the steering touch sensor 126.

For example, the second recognition unit 32 can recognize the direction of the line of sight of the driver based on a vehicle interior image captured by the occupant camera 124. At this time, the second recognition unit 32 may recognize a direction of the face of the driver as the direction of the line of sight of the driver. That is, the “direction of the line of sight of the driver” in the following description may be replaced with the “direction of the face of the driver”.

The alarm control unit 33 issues an alarm to the driver via the alarm device 90 based on the surrounding situation recognized by the first recognition unit 31 and the driving situation recognized by the second recognition unit 32. For example, the alarm control unit 33 issues an alarm to the driver by displaying a predetermined alarm image on the MID 91 in the alarm device 90. The alarm control unit 33 may issue an alarm to the driver by outputting a predetermined alarm sound from the buzzer 92 in the alarm device 90 instead of or in addition to the alarm image to the MID 91.

More specifically, when a predetermined execution condition (hereinafter, also referred to as an “alarm condition”) is satisfied based on the surrounding situation recognized by the first recognition unit 31, the alarm control unit 33 issues an alarm to the driver at a predetermined alarm intensity. In the following description, the alarm control unit 33 determines, based on the surrounding situation recognized by the first recognition unit 31 and the alarm condition, whether there is a possibility that the vehicle 1 departs from the host lane, and when it is determined that there is a possibility that the vehicle 1 departs from the host lane, the alarm control unit 33 issues an alarm to the driver.

The alarm condition is determined using, for example, a distance from the vehicle 1 to a traveling lane boundary. In this case, when the distance from the vehicle 1 to the traveling lane boundary of the host lane, which is recognized by the first recognition unit 31, is equal to or smaller than a predetermined value determined as the alarm condition, the alarm control unit 33 determines that there is a possibility that the vehicle 1 departs from the host lane, and issues an alarm to the driver. Accordingly, when there is a possibility that the vehicle 1 departs from the host lane, it is possible to call the driver's attention based on the alarm and prevent the departure of the vehicle 1 from the host lane. Accordingly, a decrease in safety due to departure of the vehicle 1 from the host lane can be prevented, and the safety of the vehicle 1 is improved.

The alarm condition may be determined using a time required until the vehicle 1 reaches a traveling lane boundary (that is, a time to line crossing (TTLC)). A smaller value of TTLC indicates a higher possibility of the vehicle 1 approaching the traveling lane boundary, that is, a higher possibility of the vehicle 1 departing from the host lane. Therefore, in this case, when the time required until reaching the traveling lane boundary of the host lane (TTLC), which is recognized by the first recognition unit 31, is equal to or smaller than a predetermined value determined as the alarm condition, it is sufficient for the alarm control unit 33 to determine that there is a possibility that the vehicle 1 departs from the host lane, and issue an alarm to the driver.

In some cases, the driver intentionally brings the vehicle 1 close to the traveling lane boundary of the host lane. As an example, “in-cut” in which the vehicle 1 is caused to travel close to an inner side of a curve in the host lane may be intentionally performed by the driver. When the driver intentionally brings the vehicle 1 close to the traveling lane boundary of the host lane as described, if an alarm is still issued, the driver may be bothered.

Therefore, when at least one of the steering condition with respect to the vehicle 1 and the direction of the line of sight of the driver satisfies a predetermined condition (hereinafter, also referred to as an “alarm reduction condition”), the alarm control unit 33 makes an execution condition of an alarm to the driver (that is, the alarm condition) stricter and/or decreases an alarm intensity of the alarm to the driver, as compared with a case where the alarm reduction condition is not satisfied. In other words, when at least one of the steering condition with respect to the vehicle 1 and the direction of the line of sight of the driver satisfies the alarm reduction condition, the alarm control unit 33 executes one of the following (1), (2), and (3).
(1) Make the execution condition of an alarm stricter as compared with the case where the alarm reduction condition is not satisfied.
(2) Decrease the alarm intensity as compared with the case where the alarm reduction condition is not satisfied.
(3) Make the execution condition of an alarm stricter and decrease the alarm intensity as compared with the case where the alarm reduction condition is not satisfied.

Although a specific example will be described later, the alarm reduction condition is set in advance by the manufacturer of the vehicle 1 or the like in consideration of matters that are more likely to be established in a case of intentional driving of the driver than in a case of unintentional driving of the driver. Accordingly, it is possible to prevent an alarm having a high alarm intensity or just an alarm from being issued with respect to intentional driving of the driver. On the other hand, since an alarm having a high alarm intensity or just an alarm can be issued under a loose alarm condition in the case of unintentional driving of the driver as compared with the case of intentional driving of the driver, it is possible to call the driver's attention with the alarm. Accordingly, it is possible to appropriately issue an alarm while preventing excessive alarming that may bother the driver.

The control device 30 may further include a steering control unit 34, for example, as a functional unit implemented by the processor executing a program stored in the storage unit of the control device 30. In this case, the steering control unit 34 is configured to execute steering control of assisting the steering with respect to the vehicle 1 based on the surrounding situation recognized by the first recognition unit 31 such that the vehicle 1 does not depart from the host lane. Hereinafter, it is assumed that control of assisting the steering such that the vehicle 1 travels while staying near a center of the host lane (hereinafter also referred to as a “lane keep assist system (LKAS)”) can be executed, as an example of the steering control. For example, the steering control unit 34 executes the LKAS based on a fact that an operation of turning on the LKAS is detected by the operation detection unit 125. Since a detailed control procedure for implementing the LKAS is well known, a detailed description thereof is omitted here.

When the LKAS is being executed by the steering control unit 34, even if an alarm having a high alarm intensity or just an alarm is not issued, the possibility that the vehicle 1 departs from the host lane is reduced than when the LKAS is not being executed.

Therefore, in a case where the LKAS is in operation (in other words, the LKAS is being executed by the steering control unit 34) and at least one of the steering condition with respect to the vehicle 1 and the direction of the line of sight of the driver satisfies the alarm reduction condition, the alarm control unit 33 makes the alarm condition (that is, the execution condition of an alarm) stricter and/or decreases the alarm intensity as compared with the case where the alarm reduction condition is not satisfied.

As described, when the possibility that the vehicle 1 departs from the host lane is low even if the alarm condition is made stricter and/or the alarm intensity is reduced since a configuration in which the alarm condition can be made stricter and/or the alarm intensity can be reduced during the operation of the LKAS is adopted, it is possible to prevent an alarm having a high alarm intensity or just an alarm from being issued. Accordingly, it is possible to prevent excessive alarming that may bother the driver while preventing a decrease in safety due to departure of the vehicle 1 from the host lane.

When the vehicle 1 approaches the traveling lane boundary of the host lane even though the LKAS is in operation, there is a high possibility that the approach is caused by the driver's intentional driving. For this reason, as described above, by making the alarm condition strict and/or decreasing the alarm intensity during the operation of the LKAS, it is possible to prevent an alarm having a high alarm intensity or just an alarm from being issued with respect to the intentional driving of the driver. Accordingly, it is possible to prevent excessive alarming that may bother the driver.

The alarm reduction condition includes, for example, a condition that the line of sight of the driver is directed toward a center of the host lane or toward an inner side of a curve with respect to the center. That is, when the line of sight of the driver is directed toward the center of the host lane or toward the inner side of the curve with respect to the center, there is a possibility that the in-cut is intentionally performed. Therefore, the condition that the line of sight of the driver is directed toward a center of the host lane or toward an inner side of a curve with respect to the center is included in the alarm reduction condition. Accordingly, when the driver intentionally performs the in-cut, it is possible to prevent excessive alarming that may bother the driver.

The alarm reduction condition may include a condition that the steering torque TQ is equal to or greater than a predetermined value. For example, when the vehicle 1 approaches the traveling lane boundary of the host lane during the operation of the LKAS, a torque is applied to the steering 46 by the EPS system 40 to achieve the steering angle θst for directing the vehicle 1 to the center of the host lane. In such a case, in order to achieve the steering angle θst for directing the vehicle 1 to the traveling lane boundary of the host lane, the driver needs to apply a larger torque to the steering 46. That is, when the vehicle 1 approaches the traveling lane boundary of the host lane during the operation of the LKAS and the steering torque TQ is equal to or greater than a predetermined value, there is a high possibility that the approach is caused by the driver's intentional driving.

Therefore, the condition that the steering torque TQ is equal to or greater than a predetermined value is included in the alarm reduction condition. Accordingly, it is possible to prevent an alarm having a high alarm intensity or just an alarm from being issued with respect to the intentional driving of the driver. Accordingly, it is possible to prevent excessive alarming that may bother the driver. Here, the predetermined value is set in advance by the manufacturer of the vehicle 1 or the like in consideration of, for example, a torque that may be applied to the steering 46 by the EPS system 40 so that the vehicle 1 travels while staying near the center of the host lane during the operation of the LKAS.

The alarm reduction condition may include a condition that the steering 46 is being gripped. That is, in a case where the steering 46 is being appropriately gripped by the driver, when the vehicle 1 is about to depart from the host lane, the driver can immediately steer the vehicle 1 to avoid the departure. Therefore, the condition that the steering 46 is being gripped is included in the alarm reduction condition. Accordingly, when it is assumed that the driver can steer to avoid a risk, it is possible to prevent excessive alarming that may bother the driver.

When a state in which the alarm reduction condition is satisfied continues for a predetermined time (for example, 3 [s]), the alarm control unit 33 may make the alarm condition stricter and/or decrease the alarm intensity. In this way, it is possible to prevent a situation where the alarm condition is made stricter and/or the alarm intensity is decreased when the alarm reduction condition is satisfied accidentally for a short time. Accordingly, the alarm to the driver can be appropriately issued, and the safety of the vehicle 1 is improved. Here, the predetermined time is set in advance by the manufacturer of the vehicle 1 or the like, for example.

As an example, when a state in which the line of sight of the driver is directed toward a center of the host lane or toward an inner side of a curve with respect to the center continues for a predetermined time, the alarm control unit 33 may make the alarm condition stricter and/or decrease the alarm intensity. As another example, when a state in which the steering torque TQ is equal to or greater than a predetermined value continues for a predetermined time, the alarm control unit 33 may make the alarm condition stricter and/or decrease the alarm intensity. Further, as another example, when a state in which the steering 46 is appropriately gripped continues for a predetermined time, the alarm control unit 33 may make the alarm condition stricter and/or decrease the alarm intensity.

In a case where a width of the host lane is smaller than a predetermined value, the vehicle 1 is more likely to approach the traveling lane boundary of the host lane (that is, the traveling lane boundary that defines the host lane) as compared with a case where the width is equal to or greater than the predetermined value. Therefore, in the case where the width of the host lane is smaller than the predetermined value, if the alarm is also issued under the same alarm conditions as in the case where the width is equal to or greater than the predetermined value, excessive warning that may bother the driver is likely to occur.

Therefore, when the width of the host lane is smaller than a predetermined value (for example, 3 [m]), the alarm control unit 33 may make the alarm condition stricter and/or decrease the alarm intensity of the alarm, as compared with the case where the width is equal to or greater than the predetermined value. As described, when the width of the host lane is smaller than a predetermined value, it is possible to prevent excessive alarming, which may bother the driver, by preventing an alarm having a high alarm intensity or just an alarm from being issued.

When an obstacle whose distance from the vehicle 1 is equal to or smaller than a threshold is recognized, the alarm control unit 33 may set the alarm condition to a normal execution condition and/or set the alarm intensity to a normal alarm intensity. Accordingly, it is possible to prevent a decrease in safety of the vehicle 1 that is caused by making the alarm condition stricter and/or decreasing the alarm intensity even though an obstacle is present around the vehicle 1.

More specifically, for example, it is assumed that the in-cut is intentionally performed by the driver and the vehicle 1 travels close to a traveling lane boundary on an inner side of a curve in the host lane. When such intentional in-cut is performed, in the vehicle 1, as described above, the alarm condition is made stricter or the alarm intensity is decreased. It is assumed that the vehicle 1 approaches another vehicle traveling in another lane that is present on an inner side of a curve with respect to the host lane in a state where the alarm condition is made stricter and/or in a state where the alarm intensity is decreased. In such a case, the other vehicle is recognized by the first recognition unit 31 as an obstacle whose distance from the vehicle 1 is equal to or smaller than the threshold. In such a case, the alarm control unit 33 may set the alarm condition to a normal execution condition (for example, the most relaxed alarm condition among settable alarm conditions) or set the alarm intensity to a normal alarm intensity (for example, the highest alarm intensity among settable alarm intensities).

Further, a case is considered in which reliability of a surrounding situation recognized by the first recognition unit 31 (for example, a relative position between the vehicle 1 and an object present around the vehicle 1) may not be sufficient due to several factors such as bad weather, a bad road surface condition, or a failure of the external sensor 11. From the viewpoint of ensuring the safety of the vehicle 1, it is not preferable to make the alarm condition stricter or decrease the alarm intensity when the vehicle is unstable in control.

Therefore, when the reliability of the surrounding situation recognized by the first recognition unit 31 is a predetermined value and the alarm reduction condition is satisfied, the alarm control unit 33 may make the alarm condition stricter and/or decrease the alarm intensity. In other words, in a case where the reliability of the surrounding situation recognized by the first recognition unit 31 is less than the predetermined value, even if the alarm reduction condition is satisfied, the alarm control unit 33 may not make the alarm condition stricter or decrease the alarm intensity. Accordingly, it is possible to prevent a situation in which, when the vehicle 1 is unstable in control, the alarm condition is made stricter or the alarm intensity is decreased, causing a decrease in safety of the vehicle 1. In this case, for example, the control device 30 or the like may further include a processing unit that evaluates, according to a predetermined condition, the reliability of the surrounding situation recognized by the first recognition unit 31 and transmits an evaluation result to the alarm control unit 33.

Similarly to the above, from the viewpoint of ensuring the safety of the vehicle 1, the alarm condition may be made stricter and/or the alarm intensity may be decreased only when the relative position between the vehicle 1 and the object around the vehicle 1 can be appropriately recognized by the first recognition unit 31 and the alarm reduction condition is satisfied.

### Processing Executed by Control Device

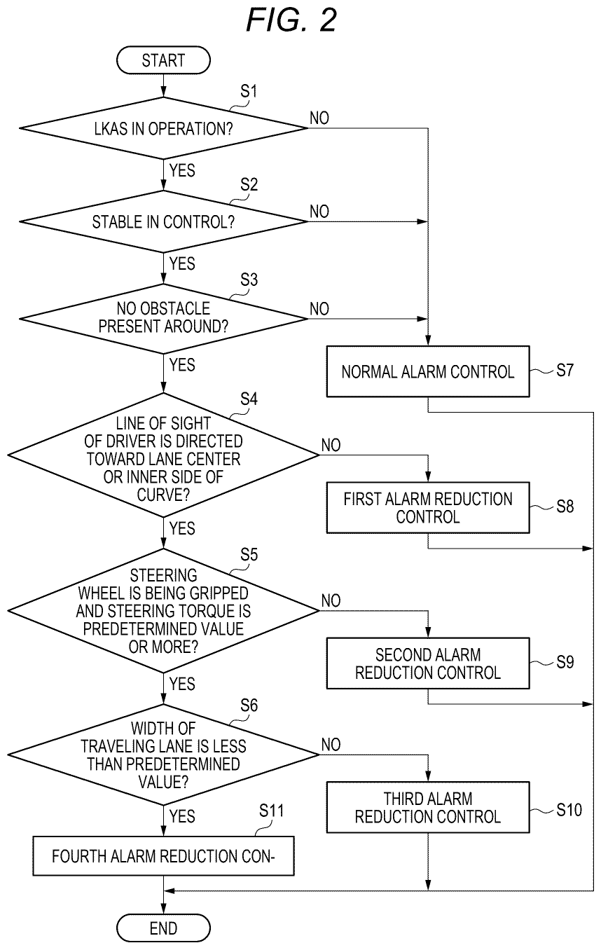

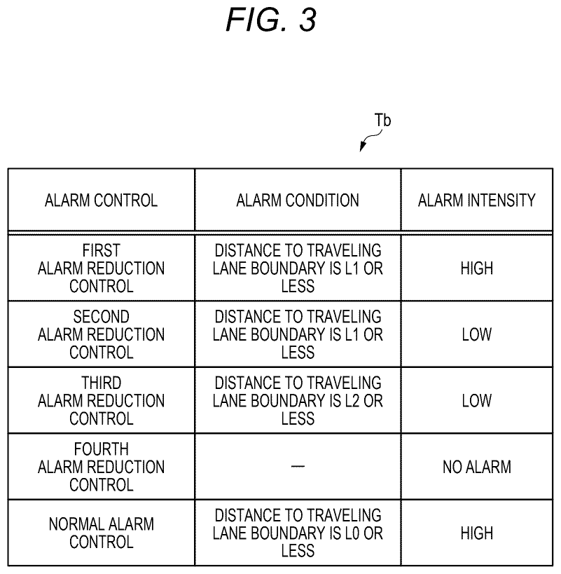

Next, an example of alarm control processing executed by the control device 30 will be described with reference to FIGS. 2 and 3. For example, when an ignition power supply of the vehicle 1 is turned on, the control device 30 repeatedly executes a series of processing illustrated in FIG. 2 at a predetermined cycle. At this time, for example, the control device 30 determines the alarm condition and the alarm intensity by appropriately referring to an alarm control table Tb illustrated in FIG. 3.

As illustrated in FIG. 2, the control device 30 first determines whether the LKAS is in operation (step S1). If it is determined that the LKAS is not in operation (step S1: NO), the control device 30 executes normal alarm control (step S7), and ends the series of processing illustrated in FIG. 2.

In the normal alarm control of step S7, for example, the control device 30 issues an alarm to the driver at a relatively high alarm intensity when a distance to a traveling lane boundary of a host lane is equal to or smaller than L0 (for example, 0.5 [m]) as illustrated in FIG. 3. As an example of the alarm according to the normal alarm control (in other words, an alarm having a high alarm intensity), both display of an alarm image on the MID 91 and output of an alarm sound from the buzzer 92 can be performed.

As described above, when the LKAS is not in operation, the control device 30 performs the normal alarm control in which an alarm having a high alarm intensity can be performed under the most relaxed alarm condition, whereby a decrease in safety of the vehicle 1 can be prevented.

On the other hand, if it is determined that the LKAS is in operation (step S1: YES), the control device 30 determines whether the vehicle 1 is stable in control (step S2). For example, when the reliability of the surrounding situation recognized by the first recognition unit 31 is less than a predetermined value or the first recognition unit 31 cannot appropriately recognize a relative position between the vehicle 1 and an object around the vehicle 1, the control device 30 determines that the vehicle 1 is unstable in control.

If it is determined that the vehicle 1 is unstable in control (step S2: NO), the control device 30 performs the normal alarm control in step S7, and ends the series of processing illustrated in FIG. 2. As described, when the vehicle 1 is unstable in control, the control device 30 executes the normal alarm control in which an alarm having a high alarm intensity can be performed under the most relaxed alarm condition, whereby it is possible to prevent a decrease in safety of the vehicle 1 caused due to a fact that alarms are reduced even though the vehicle 1 is unstable in control.

On the other hand, if it is determined that the vehicle 1 is stable in control (step S2: YES), the control device 30 determines whether no obstacle is present around the vehicle 1 (step S3). For example, when an obstacle whose distance from the vehicle 1 is equal to or smaller than a threshold is recognized, the control device 30 determines that an obstacle is present around the vehicle 1.

If it is determined that an obstacle is present around the vehicle 1 (step S3: YES), the control device 30 executes the normal alarm control in step S7, and ends the series of processing illustrated in FIG. 2. As described, when an obstacle is present around the vehicle 1, the control device 30 executes the normal alarm control, whereby it is possible to prevent a decrease in safety of the vehicle 1 due to a fact that alarms are reduced even though an obstacle is present around the vehicle 1.

On the other hand, if it is determined that no obstacle is present around the vehicle 1 (step S3: NO), the control device 30 determines whether a line of sight of a driver is directed toward a center of a host lane or toward an inner side of a curve with respect to the center (step S4). If it is determined that the line of sight of the driver is not directed toward the center of the host lane nor toward the inner side of the curve (step S4: NO), the control device 30 executes first alarm reduction control (step S8), and ends the series of processing illustrated in FIG. 2.

In the first alarm reduction control of step S8, for example, the control device 30 issues an alarm to the driver at a relatively high alarm intensity when a distance to a traveling lane boundary of the host lane is L1 (for example, L1=0.3 [m], where L1<L0) as illustrated in FIG. 3. For example, the alarm according to the first alarm reduction control may have a high alarm intensity as the alarm according to the normal alarm control, and more specifically, both display of an alarm image on the MID 91 and output of an alarm sound from the buzzer 92 can be performed. That is, in the first alarm reduction control, it is determined whether to perform alarming using an alarm condition that is stricter than in the normal alarm control, and when it is determined to perform alarming, an alarm having a high alarm intensity is issued.

As described, when the line of sight of the driver is not directed toward the center of the host lane nor toward the inner side of the curve (for example, when the driver performs in-cut unintentionally), the control device 30 executes the first alarm reduction control. Thus, it is possible to prevent the alarm condition from being made excessively strict or the alarm intensity from being excessively decreased as compared with a case where second alarm reduction control or third alarm reduction control described later is executed.

If it is determined that the line of sight of the driver is directed toward the center of the host lane or toward the inner side of the curve with respect to the center (step S4: YES), the control device 30 determines whether the steering 46 is being gripped appropriately and the steering torque TQ is equal to or greater than a predetermined value (step S5).

If it is determined that the steering 46 is not being gripped or the steering torque TQ is smaller than the predetermined value (step S5: NO), the control device 30 executes the second alarm reduction control (step S9).

In the second alarm reduction control of step S9, for example, the control device 30 issues an alarm to the driver at a relatively low alarm intensity when a distance to a traveling lane boundary of the host lane is equal to or smaller than L1 as illustrated in FIG. 3. As an example of the alarm according to the second alarm reduction control (in other words, an alarm having a low alarm intensity), only one of display of an alarm image on the MID 91 and output of an alarm sound from the buzzer 92 (for example, only the display of an alarm image on the MID 91) can be performed. That is, in the second alarm reduction control, it is determined, as in the first alarm reduction control, whether to perform alarming using an alarm condition that is stricter than in the normal alarm control, and when it is determined to perform alarming, an alarm having a low alarm intensity is issued.

On the other hand, if it is determined that the steering 46 is being gripped appropriately and the steering torque TQ is equal to or greater than the predetermined value (step S5: YES), the control device 30 determines whether a width of the host lane is smaller than a predetermined value (step S6).

If it is determined that the width of the host lane is equal to or greater than the predetermined value (step S6: NO), the control device 30 executes the third alarm reduction control (step S10), and ends the series of processing illustrated in FIG. 2. In the third alarm reduction control of step S10, for example, the control device 30 issues an alarm to the driver at a relatively low alarm intensity when a distance to a traveling lane boundary of the host lane is L2 (for example, L2=0.2 [m], where L2<L1) as illustrated in FIG. 3. For example, the alarm according to the third alarm reduction control may have a high alarm intensity as the alarm according to the second alarm reduction control, and more specifically, only one of display of an alarm image on the MID 91 and output of an alarm sound from the buzzer 92 can be performed. That is, in the third alarm reduction control, it is determined whether to perform alarming using an alarm condition that is further stricter than in the first alarm reduction control and the second alarm reduction control, and when it is determined to perform alarming, an alarm having a low alarm intensity is issued.

On the other hand, if it is determined that the width of the host lane is smaller than the predetermined value (step S6: YES), the control device 30 executes fourth alarm reduction control (step S11), and ends the series of processing illustrated in FIG. 2. In the fourth alarm reduction control of step S11, for example, the control device 30 does not issue an alarm to the driver regardless of the distance to the traveling lane boundary of the host lane as illustrated in FIG. 3.

As described above, according to the control device 30, it is possible to appropriately issue an alarm to the driver while preventing excessive alarming that may bother the driver.

Although an embodiment of the present disclosure has been described above with reference to the drawings, it goes without saying that the present disclosure is not limited to the embodiment described above. It is apparent that those skilled in the art can conceive of various modifications and changes within the scope described in the claims, and it is understood that such modifications and changes naturally fall within the technical scope of the present disclosure.

For example, the control device 30 may store information indicating a curvature of a curve, a vehicle speed VP, a width, a departure amount, and the like in a case where a departure from a host lane of the vehicle 1 occurs, and may determine whether to perform an alarm using the stored information. As an example, the control device 30 may predict a departure amount from a host lane this time based on a curvature of a curve, a vehicle speed VP, a width, and a departure amount in a case where the vehicle 1 departed from a host lane in the past, and a current curvature of a curve, a current vehicle speed VP, and a current width. Then, the control device 30 may determine whether a distance between the vehicle 1 and a line, which is expanded outward from a traveling lane boundary of the current host lane by the predicted departure amount, is equal to or smaller than a predetermined value defined as an alarm condition, and may issue an alarm based on a determination result.

In the embodiment described above, the control device 30 determines whether the vehicle 1 is stable in control (step S2), and if it is determined that the vehicle 1 is stable in control (step S2: YES), the control device 30 can execute various types of alarm reduction control such as the first alarm reduction control, the second alarm reduction control, and the third alarm reduction control, and the present disclosure is not limited thereto. For example, the control device 30 may execute various types of alarm reduction control without executing the processing of step S2.

In the present specification, at least the following matters are described. Although corresponding constituent elements in the embodiment described above are shown in parentheses, the present disclosure is not limited thereto.

(1) A vehicle control device (control device 30) for controlling a vehicle (vehicle 1), the vehicle control device including:
a first recognition unit (first recognition unit 31) configured to recognize a surrounding situation of the vehicle;
a second recognition unit (second recognition unit 32) configured to recognize a driving status of the vehicle involving a driver; and
an alarm control unit (alarm control unit 33) configured to issue an alarm to the driver via a predetermined alarm device (alarm device 90) based on a surrounding situation recognized by the first recognition unit and a driving status recognized by the second recognition unit, in which
the second recognition unit recognizes the driving status including a steering condition with respect to the vehicle and a direction of a line of sight of the driver,
the alarm control unit is capable of issuing the alarm at a predetermined alarm intensity when a predetermined execution condition is satisfied based on the surrounding situation, and
in a case where at least one of the steering condition and the direction of the line of sight satisfies a predetermined condition, the alarm control unit makes the execution condition stricter and/or decreases the alarm intensity as compared with a case where the predetermined condition is not satisfied.

According to (1), when at least one of the steering condition with respect to the vehicle and the direction of the line of sight of the driver satisfies the predetermined condition, the execution condition of the alarm based on the surrounding situation of the vehicle can be made stricter, and/or the alarm intensity can be decreased. Accordingly, it is possible to appropriately issue an alarm to the driver while preventing excessive alarming that may bother the driver, and the safety of the vehicle is improved. In addition, it is possible to improve traffic safety and contribute to development of a sustainable transportation system.

(2) The vehicle control device according to (1), in which
the first recognition unit recognizes the surrounding situation including a shape of a lane in which the vehicle travels,
the vehicle control device further includes a steering control unit (steering control unit 34) configured to perform steering control of assisting steering of the vehicle based on the surrounding situation such that the vehicle does not depart from the lane, and
the alarm control unit makes the execution condition stricter and/or decreases the alarm intensity when the predetermined condition is satisfied during operation of the steering control.

According to (2), when the steering control of assisting the steering of the vehicle such that the vehicle does not depart from the lane is in operation, the execution condition of the alarm can be made stricter, and/or the alarm intensity can be decreased. Accordingly, when the safety of the vehicle is unlikely to decrease even if the execution condition of the alarm is made stricter and/or the alarm intensity is decreased, the execution condition of the alarm can be made stricter and/or the alarm intensity can be decreased. Accordingly, it is possible to prevent excessive alarming that may bother the driver while preventing a decrease in safety of the vehicle.

(3) The vehicle control device according to (2), in which
the predetermined condition includes a condition that the line of sight is directed toward a center of the lane or toward an inner side of a curve with respect to the center.

When the line of sight of the driver is directed toward the center of the lane in which the vehicle travels or toward the inner side of the curve with respect to the center, there is a possibility that the driver is intentionally performing in-cut. According to (3), it is possible to prevent excessive alarming, which may bother the driver, when such intentional in-cut is performed.

(4) The vehicle control device according to (2), in which
the second recognition unit recognizes the steering condition including a steering torque (steering torque TQ) generated in a steering (steering 46) of the vehicle, and
the predetermined condition includes a condition that the steering torque is equal to or greater than a predetermined value.

When the steering torque is equal to or greater than the predetermined value, there is a possibility that the driver is intentionally performing in-cut. According to (4), it is possible to prevent excessive alarming, which may bother the driver, when such intentional in-cut is performed.

(5) The vehicle control device according to (2), in which
the second recognition unit recognizes the steering condition including a gripping state of a steering (steering 46) of the vehicle, and
the predetermined condition includes a condition that the steering is being gripped.

In a case where the steering is being appropriately gripped by the driver, when the vehicle is about to depart from the lane, the driver can immediately steer the vehicle to avoid the departure. According to (5), when it is assumed that the driver can steer to avoid a risk, it is possible to prevent excessive alarming that may bother the driver.

(6) The vehicle control device according to any one of (1) to (5), in which
the alarm control unit makes the execution condition stricter and/or decreases the alarm intensity when a state in which the predetermined condition is satisfied continues for a predetermined time.

According to (6), it is possible to prevent a situation where the execution condition of the alarm is made stricter and/or the alarm intensity is decreased when the predetermined condition is satisfied accidentally. Accordingly, the alarm to the driver can be appropriately issued, and the safety of the vehicle is improved.

(7) The vehicle control device according to any one of (2) to (5), in which
in a case where a width of the lane in which the vehicle travels is smaller than a predetermined value, the alarm control unit makes the execution condition stricter and/or decreases the alarm intensity as compared with a case where the width is equal to or greater than the predetermined value.

In the case where the width of the lane in which the vehicle travels is smaller than the predetermined value, the vehicle is more likely to approach a travelling lane boundary that defines the lane, as compared with the case where the width is equal to or greater than the predetermined value. Therefore, in the case where the width of the lane is smaller than the predetermined value, if the alarm is also issued under the same alarm conditions as in the case where the width is equal to or greater than the predetermined value, excessive warning that may bother the driver is likely to occur. According to (7), in the case where the width of the lane in which the vehicle travels is smaller than the predetermined value, it is possible to prevent excessive alarming, which may bother the driver, by making the execution condition of the alarm stricter and/or decreasing the alarm intensity.

(8) The vehicle control device according to any one of (1) to (7), in which
when reliability of the surrounding situation recognized by the first recognition unit is a predetermined value and satisfies the predetermined condition, the alarm control unit makes the execution condition stricter and/or decreases the alarm intensity.

A case is also considered in which the reliability of the surrounding situation recognized by the first recognition unit is not sufficient due to several factors. From the viewpoint of ensuring the safety of the vehicle, it is not preferable to make the alarm condition stricter or decrease the alarm intensity when the vehicle is unstable in control. According to (8), it is possible to prevent a situation in which, when the vehicle is unstable in control, the alarm condition is made stricter or the alarm intensity is decreased, causing a decrease in safety of the vehicle.

(9) The vehicle control device according to any one of (1) to (8), in which
the first recognition unit recognizes the surrounding situation including an obstacle present around the vehicle, and
the alarm control unit sets the execution condition to a normal execution condition and/or sets the alarm intensity to a normal alarm intensity when the obstacle whose distance from the vehicle is equal to or smaller than a threshold is recognized.

According to (9), when an obstacle is present around the vehicle, the execution condition of the alarm is set to the normal execution condition and/or the alarm intensity is set to the normal alarm intensity, whereby it is possible to prevent a decrease in safety of the vehicle due to a fact that the execution condition of the alarm is made stricter and/or the alarm intensity is decreased even though the obstacle is present around the vehicle.

1. A vehicle control device for controlling a vehicle, wherein the vehicle control device comprising circuitry configured to:
recognize a surrounding situation of the vehicle;
recognize a driving status of the vehicle involving a driver; and
issue an alarm to the driver via a predetermined alarm device based on the recognized surrounding situation and the recognized driving status, wherein
the circuitry is configured to recognize the driving status including a steering condition with respect to the vehicle and a direction of a line of sight of the driver,
the circuitry is configured to issue the alarm at a predetermined alarm intensity when a predetermined execution condition is satisfied based on the surrounding situation, and
in a case where at least one of the steering condition and the direction of the line of sight satisfies a predetermined condition, the circuitry is configured to make the execution condition stricter and/or decrease the alarm intensity as compared with a case where the predetermined condition is not satisfied.

2. The vehicle control device according to claim 1, wherein
the circuitry is configured to recognize the surrounding situation including a shape of a lane in which the vehicle travels,
the circuitry is further configured to perform steering control of assisting steering of the vehicle based on the surrounding situation such that the vehicle does not depart from the lane, and
the circuitry is configured to:
issue the alarm when determining, based on the surrounding situation and the execution condition, that the vehicle has a possibility to depart from the lane; and
make the execution condition stricter and/or decrease the alarm intensity when the predetermined condition is satisfied during operation of the steering control.

3. The vehicle control device according to claim 2, wherein
the predetermined condition includes a condition that the line of sight is directed toward a center of the lane or toward an inner side of a curve with respect to the center.

4. The vehicle control device according to claim 2, wherein
the circuitry is configured to recognize the steering condition including a steering torque generated in a steering of the vehicle, and
the predetermined condition includes a condition that the steering torque is equal to or greater than a predetermined value.

5. The vehicle control device according to claim 2, wherein
the circuitry is configured to recognize the steering condition including a gripping state of a steering of the vehicle, and
the predetermined condition includes a condition that the steering is being gripped.

6. The vehicle control device according to claim 1, wherein
the circuitry is configured to make the execution condition stricter and/or decrease the alarm intensity when a state in which the predetermined condition is satisfied continues for a predetermined time.

7. The vehicle control device according to claim 2, wherein
in a case where a width of the lane in which the vehicle travels is smaller than a predetermined value, the circuitry is configured to make the execution condition stricter and/or decrease the alarm intensity as compared with a case where the width is equal to or greater than the predetermined value.

8. The vehicle control device according to claim 1, wherein
when reliability of the recognized surrounding situation is a predetermined value and satisfies the predetermined condition, the circuitry is configured to make the execution condition stricter and/or decreases the alarm intensity.

9. The vehicle control device according to claim 1, wherein
the first recognition unit recognizes the surrounding situation including an obstacle present around the vehicle, and
the alarm control unit sets the execution condition to a normal execution condition and/or sets the alarm intensity to a normal alarm intensity when the obstacle whose distance from the vehicle is equal to or less than a threshold is recognized.
